(19) United States
(12) Patent Application Publication
(10) Pub. No.: US 2016/0253465 A1
(43) Pub. Date: Sep. 1, 2016

(54) NEXT GENERATION LIFESTREAM APPLICATION

(71) Applicant: Honeywell International Inc., Morristown, NJ (US)

(72) Inventors: Manoj MAHENDRA, Karnataka (IN); Girish NAYAKAR, Karnataka (IN); Som Appu KANNAMKATTIL, Kerala (IN); Manoj Thankappan NAIR, Karnataka (IN); MallikarjunaRao ANUMOLU, Karnataka (IN); Vigneshwari RAVI, TamilNadu (IN)

(73) Assignee: Honeywell International Inc.

(21) Appl. No.: 14/633,252

(22) Filed: Feb. 27, 2015

(51) Int. Cl. G06F 19/00; H04L 29/08

(52) U.S. Cl. CPC G06F 19/345; G06F 19/3481; G06F 19/363; H04L 67/02

(57) ABSTRACT

A method including a healthcare server of a healthcare person receiving an Internet packet including vital signs of a human patient, a processor of the healthcare server automatically providing acknowledgement to the human patient of receipt of the vital signs, a processor the healthcare server sending a visual explanation to the human patient explaining an impact of patient behavior on the patient's health and suggested changes based upon the patient's vital signs and a processor the healthcare server presenting a set of alert limits for the vital signs of the human patient to the healthcare person based upon a set of rules for the human patient and similarly situated human patients

### FIELD

This application relates to healthcare monitoring and more particular to home healthcare monitoring.

### BACKGROUND

Systems are known to monitor the vital signs (e.g., heart rate, blood pressure, respiration, etc.) of people. Such systems typically include a control unit and one or more sensors connected directly to a patient. The control unit typically takes a reading at some appropriate time interval (e.g., every 30 seconds, once a minute, etc.) and compares that reading with a threshold value. If the reading exceeds a corresponding threshold value, then the control unit may sound an audible alarm.

Such systems work well in a hospital setting, where a nurse or other healthcare worker is proximate the patient. In these cases, the nurse or other healthcare worker can offer immediate aid in the event of a health crisis.

However, many human patients are often confined to their homes. This may be because they don't have adequate health insurance or because their conditions do not merit the cost of a hospital stay.

In the case where a patient is confined to a home, the monitoring system is typically equipped with a communication system that automatically reports vital signs to a remotely located healthcare server. In addition to saving the vital signs into a database, the healthcare server may also send the data to a human healthcare worker responsible for the care of the patient.

The healthcare worker may review the data and periodically visit the patient. During the visit, the healthcare worker may review the patient's condition and/or strive to identify any new symptoms.

While existing remotely located systems works relatively well, they do not always benefit patients as they should. For example, if a healthcare worker is out of the office when a health event occurs, the worker may not become aware of the problem until much later. This leads to unnecessary hospital visits. Accordingly, a need exists for better methods of connecting patients and healthcare workers.

### BRIEF DESCRIPTION OF THE DRAWINGS

FIG. 1 illustrates a block diagram of a system in accordance herewith;

FIG. 2 is a flow chart of steps that may be performed to validate data received by the system of FIG. 1;

FIG. 3 is a flow chart of steps that may be performed by the system of FIG. 1 to identify visual information for presentation to patients;

FIG. 4 is a flow chart of steps that may be performed by the system of FIG. 1 to set threshold for patients.

### DETAILED DESCRIPTION

While disclosed embodiments can take many different forms, specific embodiments thereof are shown in the drawings and will be described herein in detail with the understanding that the present disclosure is to be considered as an exemplification of the principles thereof as well as the best mode of practicing same, and is not intended to limit the application or claims to the specific embodiment illustrated.

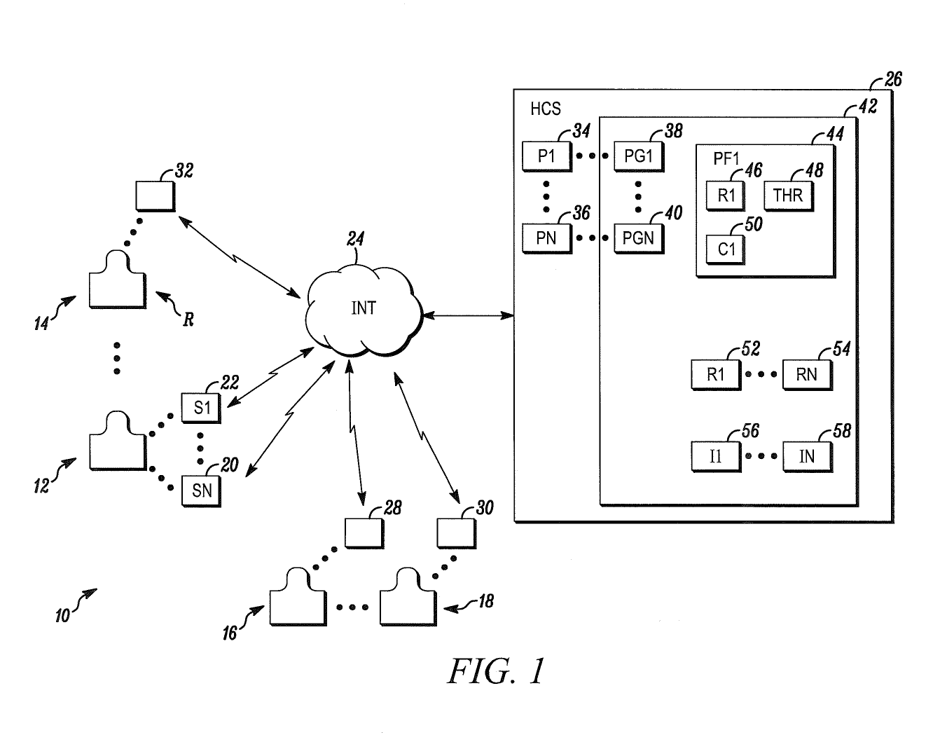

FIG. 1 is a block diagram of a healthcare monitoring system 10 shown generally in accordance with an illustrated embodiment. Under the illustrated embodiment, a number of human patients 12, 14, each located within the respective residence R of the patient, may be monitored by one or more human healthcare workers 16, 18.

As part of the monitoring, the vital signs of each of the patients (e.g., heart rate, blood pressure, respiration rate, etc.) may be monitored by a healthcare worker via one or more in-home health sensing devices (sensors) 20, 22. The sensing devices may be wirelessly coupled to the healthcare worker via the Internet 24 and/or a healthcare server 26.

In this regard, each of the healthcare workers has a portable device 28, 30 that wirelessly connects to the Internet. Through the portable devices, healthcare workers can monitor the vital signs of each patient.

The healthcare system can also send information to each of the patients via a communications terminal and display (monitoring device) 32. The sensors that monitor the patient may communicate with the Internet through the terminal (or the terminal and display) may be part of a separate communication system (e.g., a personal computer of the patient) as shown in FIG. 1.

Included within the healthcare server, the terminal and display of each patient, the sensing devices and the portable device carried by each healthcare worker is one or more processing apparatus (processors) 34, 36, each operating under control of one or more computer programs 38, 40 loaded from a non-transitory computer readable medium (memory) 42. As used herein, reference to a step performed by a computer program is also reference to the processor that executed that step.

Under the illustrated embodiment, a reporting processor within each of the sensors may measure a vital parameter (e.g., blood pressure, heart rate, respiration, etc.) and send the measured parameter as an Internet packet either directly or through the terminal and display to a corresponding processor within the healthcare server. The processor of the healthcare server may save the reading into a file 44 maintained for each of the patients.

The packet may have a specific format structured to ensure the reliable receipt of vital parameters. For example, a first field of the packet may include an Internet address of the processor within the healthcare server that is intended to receive the packet. A second field may be an identifier of the parameter measured and a third field may include a reading of the vital parameter contained within the packet.

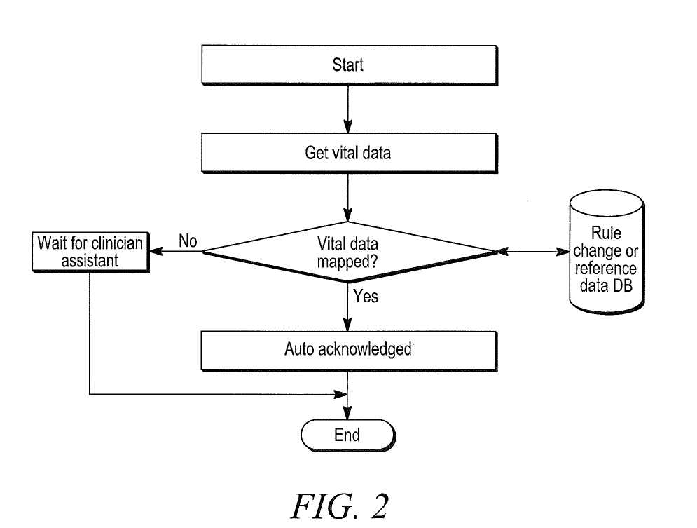

Within the server, a format processor may review the packet for compliance with the proper transmission format as shown in FIG. 2. In this regard, the format processor may retrieve or otherwise get the data and determine if the packet maps to a required format for that type of data. Mapping may be confirmed via reference data retrieved from a reference database within the server. If the packet can be mapped to the proper format (for the type of packet involved), then an acknowledgement is sent to the patient. If not, then the packet is routed to the healthcare worker for review.

During this process, the processor may compare the parameter identifier of the packet with a parameter spec to ensure that the identifier has the correct number of bits and is of a known value. The processor may also compare the measured value with a reading spec to ensure that it has the proper number of bits and is within a predefined range.

If the format processor is able to confirm that the packet is in the correct format, then the same or a related processor may send the acknowledgement to the patient. The acknowledgement may be a text message shown on the display of the patient that confirms that the measured parameter has been received and is a valid measurement.

If the parameter processor is able to confirm the reading as being valid, then the parameter is saved by the corresponding processor into a vital parameters file 46 of the patient. Next, a parameters processor may compare the validated reading with one or more threshold values 48 based upon a diagnosed condition 50 of the patient.

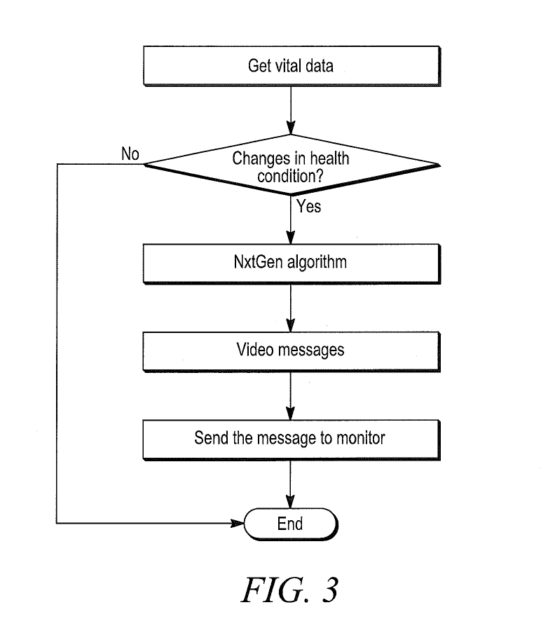

If the comparison reveals that the patient is outside of a normal range for the patient's condition, then a patient notifications processor may retrieve and send visual instructions to the patient on how to best alleviate a developing potential health crisis as shown in FIG. 3. For example, the processor may detect changes in the vital parameters over previous readings and apply a set of rules imposed by a next generation algorithm executing on the parameters processor.

In general, the server may contain a number of records and instructions 56, 58 related to the conditions of each of the patients. The records may be indexed based upon the relationship between a most recent vital parameter reading and corresponding threshold value in order to provide instructions or other actions that may be taken or otherwise implemented by a patient to alleviate any further detrimental effects. In this regard, the visual instruction retrieved from a record and sent to a patient by the next generation algorithm may be controlled by a set of rules 52, 54 related to the condition and to the patient.

The set of rules have application at a number of different levels. Under a first subset of the rules, the threshold values for each measured parameter of a patient may be established by a corresponding healthcare worker. Under a second subset of rules, the visual instructions sent to a patient may be controlled via the relationship of the latest vital parameter and corresponding threshold value.

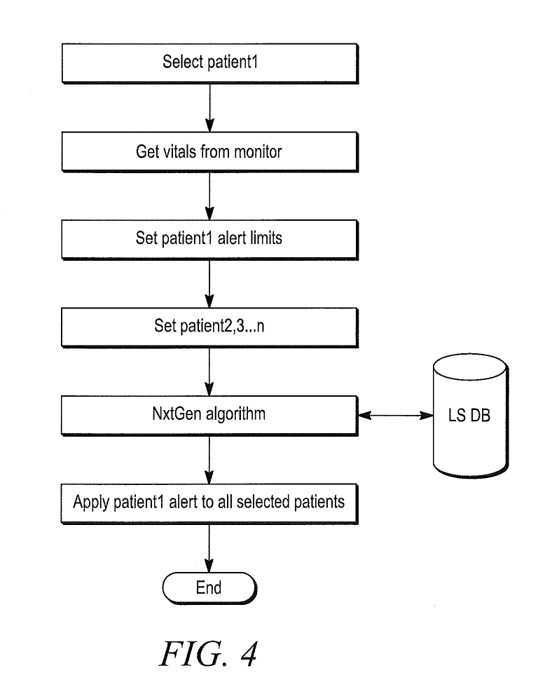

For example, under the first set of rules, a healthcare worker may select an icon on his/her portable device to activate a threshold setting processor executing the next generation algorithm on his/her portable device in order to enter a threshold setting process as shown in FIG. 4. The worker may select a patient using a name, an address or any other identifier. In response, the threshold setting processor may retrieve information from the patient file including the diagnosed condition of the patient.

Based upon the diagnosed condition, the processor may display a recommended set of thresholds for the patient. The processor may also display a set of other, similarly situated patients with the same condition. The worker may establish a set of thresholds for the patient in question and then apply the threshold values to other patients having the same condition. The display of other patients also allows the healthcare worker to determine if the threshold that he/she sets for this patient is consistent with the thresholds of other patients.

Based upon the displayed thresholds, the worker may initially establish the set of thresholds for the patient in question. The threshold may be set based upon the thresholds of similarly situation patients and the worker's own personal knowledge of the patient in question.

Once the thresholds are established, an instructions processor may monitor the vital parameters of each patient, compare those parameters and provide instructions to the patient based upon the second set of rules.

For example, a healthcare worker may set a heart rate threshold value for a person with congestive heart failure. Under the second set of rules, once the patient's heart rate rises to 80% of the threshold value, the instruction processor may send instructions to the patient advising the patient that his/her heart rate is too high and advising the patient to begin restricting their activity. On the other hand, if the patient's heart rate rises to 110% of the threshold value, then the instruction processor may send visual instructions to the patient advising him/her to call an ambulance.

The system of FIGS. 1-4 offers a number of advantages over conventional systems. For example, many conventional systems are not intuitive to use. Currently, healthcare workers are required to go through the vital sign data of patients one-at-a-time and manually acknowledge receipt of each and every reading. This presents a number of problems. First, manual intervention is required to acknowledge any type of packet. Second, manual intervention involves a delay before data is reviewed. Third, a patient is required to await return of the healthcare worker before any developing issues can be reviewed and addressed.

The structures of most convention systems are not adaptable to solve these problems. Currently, the scope of many software applications used in such systems are limited to simply managing patient data. As a result, patients are not informed about any programs/improvements in the patient's condition until the worker and patient are able to talk to one another and share information.

In addition, there is no opportunity for identifying patients with a related set of conditions or allowing a worker to apply a common set of rules to all the patients in that group. Currently, the worker has to access the data of each patient and establish rules for each patient, such as defining alarm limits for each patient. This is time consuming.

The system of FIGS. 1-4 addresses these problems in a number of ways. First, the system of FIG. 1 improves the work flow of the healthcare worker by automating the process of acknowledging the packets with minimal intervention by the worker. This reduces the effort and increases the productivity of the worker by providing a mechanism for setting common rules for related patients across the system. This improves patient satisfaction by also providing a way of educating patients about the impact of their own activities on their health. It also reduces the healthcare worker response time.

The automatic acknowledgement of packets is based upon a predetermined set of rules followed by the algorithms of FIG. 2 executing on one or more processors of the server. The automatic acknowledgement rules are predefined and are medically authorized/certified to automatically acknowledge packets from patients when the packets are in conformance with the proper format (e.g., within packet limits). As and when the packets are received by the system, this algorithm services will begin by comparing the patient packet data against the content of the programed rules and acknowledge the packet. This reduces the number of packets to be acknowledged by the healthcare worker since it is only non-conforming packets that now need to be acknowledged. Automatically acknowledged packets are archived in memory for review by the worker/physician.

Similarly, the forwarding of instructions to a patient as shown in FIG. 3 is also based upon a predetermined set of rules. An algorithm embodied as one or more programs executing on a corresponding set of processors understands existing patient data over a period of time and visually presents information about vital data that is transmitted to a patient which explains the impact of their behavior on their health and suggests changes to help prevent illness. This benefits the patient because the patient is aware of their status regarding the health condition and is more satisfied with the personnel care/attention directed towards the patient which is a factor for improving their health.

The setting of thresholds is also based upon an algorithm embodied as a set of programs executing on one or more processors. The programs provide a set of predefined parameters and/or rules for grouping patients, for instance, based on the diagnosis or treatment.

As the patient is registered into the system, there is an option for a worker to trigger the algorithm of FIG. 4 through a button a screen of the portable device that displays the list of patients based on the defined rules and suggests the most suitable alert limits that can be applied to the patient. Once the worker has chosen the alert limits, it prompts the user to validate the limits before applying the alert limits to the new patient. This operates to improve the productivity of healthcare workers.

In general, the system of FIGS. 1-4 includes a healthcare server of a healthcare person receiving an Internet packet including vital signs of a human patient, a processor of the healthcare server automatically providing acknowledgement to the human patient of receipt of the vital signs, a processor the healthcare server sending a visual explanation to the human patient explaining an impact of patient behavior on the patient's health and suggested changes based upon the patient's vital signs and a processor the healthcare server presenting a set of alert limits for the vital signs of the human patient to the healthcare person based upon a set of rules for the human patient and similarly situated human patients.

Alternatively, the system includes a communication interface of a healthcare server that receives an Internet packet of a healthcare person including vital signs of a human patient, a processor of the healthcare server that automatically provides acknowledgement to the human patient of receipt of the vital signs, a processor the healthcare server that sends a visual explanation to the human patient explaining an impact of patient behavior on the patient's health and suggested changes based upon the patient's vital signs and a processor that presents a set of alert limits for the vital signs of the human patient to the healthcare person based upon a set of rules for the human patient and similarly situated human patients.

Alternatively, the system includes a healthcare server that includes a plurality of records saved in a non-transient, computer readable memory, a communication interface of the healthcare server that receives an Internet packet of a healthcare person, the Internet packet including vital signs of a human patient, a processor of the healthcare server that confirms that a source identifier of the Internet packet corresponds to one of the plurality of records and automatically provides acknowledgement to the human patient of receipt of the vital signs, a processor the healthcare server that sends a visual explanation including one of the plurality of records to the human patient explaining an impact of patient behavior on the patient's health and suggested changes based upon the patient's vital signs and a processor that presents a set of alert limits for the vital signs of the human patient to the healthcare person based upon a set of rules for the human patient and similarly situated human patients.

From the foregoing, it will be observed that numerous variations and modifications may be effected without departing from the spirit and scope hereof. It is to be understood that no limitation with respect to the specific apparatus illustrated herein is intended or should be inferred. It is, of course, intended to cover by the appended claims all such modifications as fall within the scope of the claims. Further, logic flows depicted in the figures do not require the particular order shown, or sequential order, to achieve desirable results. Other steps may be provided, or steps may be eliminated, from the described flows, and other components may be add to, or removed from the described embodiments.

1. A method comprising:
a healthcare server of a healthcare person receiving an Internet packet including vital signs of a human patient;
a processor of the healthcare server automatically providing acknowledgement to the human patient of receipt of the vital signs;
a processor the healthcare server sending a visual explanation to the human patient explaining an impact of patient behavior on the patient's health and suggested changes based upon the patient's vital signs; and
a processor the healthcare server presenting a set of alert limits for the vital signs of the human patient to the healthcare person based upon a set of rules for the human patient and similarly situated human patients.

2. The method as in claim 1 further comprising a processor of the healthcare server confirming that a data format of the received packet conforms with a set of rules.

3. The method as in claim 1 wherein the included vital signs further comprises at least one or more of heart rate, respiration rate, blood pressure and body temperature.

4. The method as in claim 3 further comprising a processor of the healthcare server comparing the included vital signs of one or more of heart rate, respiration rate, blood pressure and body temperature with a corresponding set of threshold values.

5. The method as in claim 4 wherein the step of sending the visual explanation to the human patient explaining an impact of patient behavior on the patient's health and suggested changes based upon the patient's vital signs further comprises determining that the at least one of the heart rate, respiration rate, blood pressure and body temperature has exceeded the corresponding threshold value.

6. The method as in claim 5 further comprising retrieving a text document corresponding to the at least one of the heart rate, respiration rate, blood pressure and body temperature that exceeded the corresponding threshold value.

7. The method as in claim 6 further comprising a computer monitor of the human patient displaying the text document.

8. An apparatus comprising:
a communication interface of a healthcare server that receives an Internet packet of a healthcare person including vital signs of a human patient;
a processor of the healthcare server that automatically provides acknowledgement to the human patient of receipt of the vital signs;
a processor the healthcare server that sends a visual explanation to the human patient explaining an impact of patient behavior on the patient's health and suggested changes based upon the patient's vital signs; and
a processor that presents a set of alert limits for the vital signs of the human patient to the healthcare person based upon a set of rules for the human patient and similarly situated human patients.

9. The apparatus as in claim 8 further comprising a processor of the healthcare server that confirms that a data format of the received packet conforms with a set of rules.

10. The apparatus as in claim 8 wherein the included vital signs further comprises at least one or more of heart rate, respiration rate, blood pressure and body temperature.

11. The apparatus as in claim 10 further comprising a processor of the healthcare server that compares the included vital signs of one or more of heart rate, respiration rate, blood pressure and body temperature with a corresponding set of threshold values.

12. The apparatus as in claim 11 wherein the processor that sends the visual explanation to the human patient explaining an impact of patient behavior on the patient's health and suggested changes based upon the patient's vital signs further comprises a processor that determines that the at least one of the heart rate, respiration rate, blood pressure and body temperature has exceeded the corresponding threshold value.

13. The apparatus as in claim 12 further comprising a plurality of documents saved in a memory, each of the plurality of documents corresponding to one of heart rate, respiration rate, blood pressure and body temperature.

14. The apparatus as in claim 13 further comprising a processor that retrieves one of the plurality of text documents corresponding to the at least one of the heart rate, respiration rate, blood pressure and body temperature that exceeded the corresponding threshold value.

15. The apparatus as in claim 12 further comprising a computer monitor of the human patient that displays the text document.

16. An apparatus comprising:
a healthcare server that includes a plurality of records saved in a non-transient, computer readable memory;
a communication interface of the healthcare server that receives an Internet packet of a healthcare person, the Internet packet including vital signs of a human patient;
a processor of the healthcare server that confirms that a source identifier of the Internet packet corresponds to one of the plurality of records and automatically provides acknowledgement to the human patient of receipt of the vital signs;
a processor the healthcare server that sends a visual explanation including one of the plurality of records to the human patient explaining an impact of patient behavior on the patient's health and suggested changes based upon the patient's vital signs; and
a processor that presents a set of alert limits for the vital signs of the human patient to the healthcare person based upon a set of rules for the human patient and similarly situated human patients.

17. The apparatus as in claim 16 wherein the processor that presents the set of alert limits further comprises a processor of the healthcare server that identifies a diagnosed patient condition and retrieves a set of alert limits from one of the plurality of records based upon the diagnosed condition.

18. The apparatus as in claim 17 wherein the included vital signs further comprises at least one or more of heart rate, respiration rate, blood pressure and body temperature.

19. The apparatus as in claim 18 further comprising a processor of the healthcare server that compares the included vital signs of one or more of heart rate, respiration rate, blood pressure and body temperature with a corresponding set of threshold values of the alert limits.

20. The apparatus as in claim 19 wherein the processor that sends the visual explanation to the human patient explaining an impact of patient behavior on the patient's health and suggested changes based upon the patient's vital signs further comprises a processor that compares that the at least one of the heart rate, respiration rate, blood pressure and body temperature with the alert limits and selects the visual explanation based upon a deviation from the alert limits.
